(19) United States
(12) Patent Application Publication
(10) Pub. No.: US 2013/0007137 A1
(43) Pub. Date: Jan. 3, 2013

(54) Electronic Conversation Topic Detection

(75) Inventors: Saliha Azzam, Redmond, WA (US); Nicholas Caldwell, Bellevue, WA (US); Diego Perez Del Carpio, Redmond, WA (US)

(73) Assignee: MICROSOFT CORPORATION, Redmond, WA (US)

(21) Appl. No.: 13/171,238

(22) Filed: Jun. 28, 2011

(51) Int. Cl. G06F 15/16

(52) U.S. Cl. 709/206

(57) ABSTRACT

Automatic conversation topic detection, generation and storage are provided. Electronic conversation threads and associated metadata for a variety of types of electronic communications are retrieved. Topic properties such as keywords or terms and information about the conversation threads are extracted from the conversation threads and metadata. Extracted thread terms and properties are used for identification of a topic title associated with the conversation threads and metadata. An identified topic title is compared with previously identified topics to determine whether the identified topic is new or whether the identified topic is the same as a previously identified topic. A short and useful topic title is generated in order to allow subsequent users to know what the conversation thread is about at a glance. A user interface component may allow users to accept, reject or modify a generated topic title.

### BACKGROUND

Automatic archiving of electronic messaging communications, for example, instant messaging, electronic mail communications, and the like is commonplace within any number of business, social or academic enterprises. Oftentimes, messaging sessions are initiated with no explicit topic. For example, in a given instant messaging session, an electronic conversation may be conducted between two parties, and a topic for the session or conversation may never be generated that may be used for subsequent identification of the session or conversation. When the electronic conversation or messaging session is saved or displayed, an uninformative title may be generated such as “conversation with Bob Smith.” Unfortunately, use of such an uninformative and/or generic topic title for the conversation or messaging session may make it difficult for users subsequently to know what was actually being discussed without opening the conversation or messaging log and reading through all the messages.

It is with respect to these and other considerations that the present invention has been made.

### SUMMARY

Embodiments of the present invention solve the above and other problems by providing automatic conversation topic detection. According to embodiments, conversation threads and associated metadata for a variety of types of electronic communications (e.g., instant messaging, electronic mail, discussion boards, Internet-based chat sessions, and the like) are retrieved. Topic properties such as keywords or terms and information about the conversation threads, such as author and transmission date/time, are extracted from the conversation threads and metadata. Extracted properties are ranked for identification of a topic associated with the conversation threads and metadata. An identified topic is compared with previously identified topics to determine whether the identified topic is new or whether the identified topic is the same or similar as a previously identified topic. A short and useful topic title is generated in order allow subsequent users to know what the conversation thread is about at a glance. In addition, the topics contained within the conversation thread are stored as metadata for future use in search applications.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

The accompanying drawings, which are incorporated in and constitute a part of this disclosure, illustrate various embodiments of the present invention. In the drawings:

FIGS. 1A, 1B, and 1C illustrate a sequence of communications in an example user interface.

FIG. 1D illustrates a communication displayed in an example user interface showing a generated topic title, and FIG. 1D further illustrates a user interface component for allowing a user to accept or modify a generated topic title.

FIG. 2 illustrates a system architecture for automatically detecting and identifying a conversation topic associated with an electronic conversation thread.

FIG. 3 illustrates a process flow for automatically detecting and identifying a conversation topic associated with an electronic conversation thread.

FIG. 4 is a block diagram of a system including a computing device with which embodiments of the invention may be practiced.

### DETAILED DESCRIPTION

As briefly described above, embodiments of the present invention are directed to automatically detecting, generating and storing topics for electronic communication conversations. The following description refers to the accompanying drawings. Whenever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Referring now to the drawings, in which like numerals represent like elements through the several figures, aspects of the present invention and the exemplary operating environment will be described. While the invention will be described in the general context of program modules that execute in conjunction with an application program that runs on an operating system on a personal computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

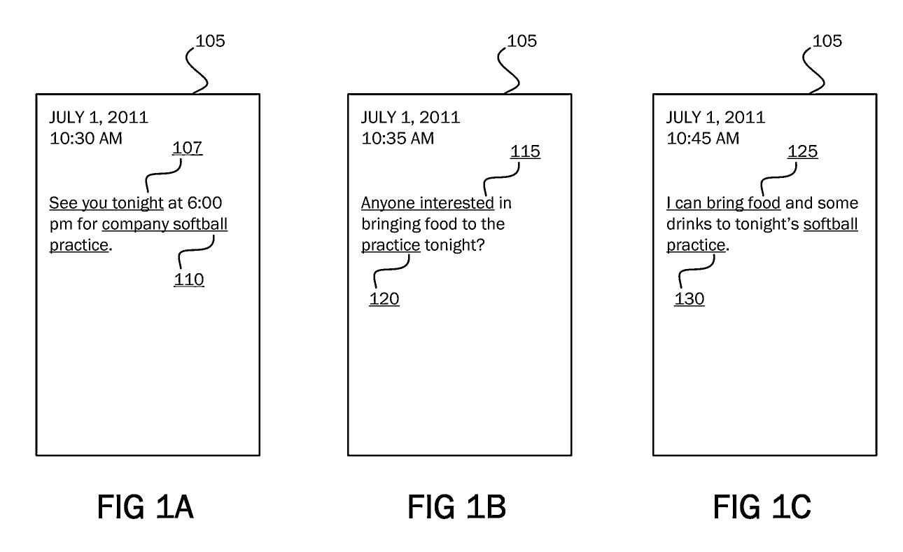

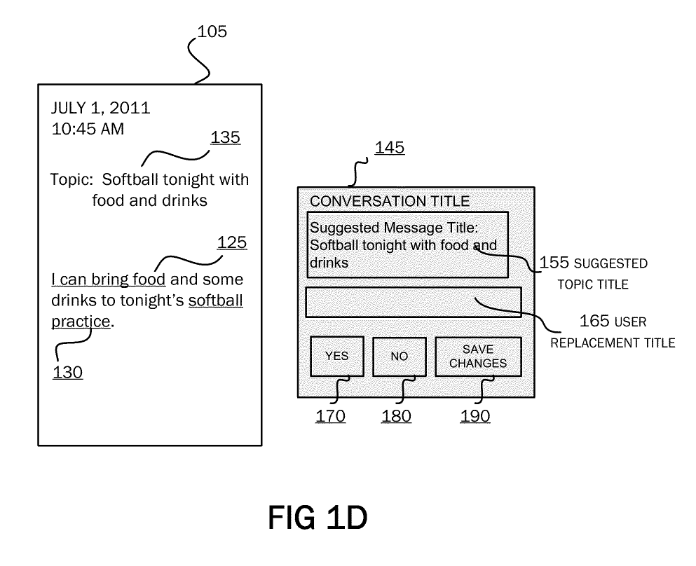

FIGS. 1A, 1B, and 1C illustrate a sequence of communications in an example user interface. In FIGS. 1A, 1B and 1C, user interface components for displaying communications, such as text messages, electronic mail messages, Internet-based chat room discussion board communications, enterprise discussion lists, and the like, are illustrated. For purposes of description, the displayed communications illustrate a sequence of messages comprising an electronic communication conversation for which a topic may be generated and stored in association with the conversation thread comprised of the sequence of messages. As will be appreciated, for any electronic communication conversation thread, a topic for the thread may be detected, generated, and stored according to embodiments of the invention.

Referring then to FIG. 1A, a first example communication is displayed on the display screen 105. The first example communication includes text of “See you tonight at 6 p.m. for company softball practice.” Without the automatic topic detection, generation and storage of the present invention, a first portion of the text string 107, for example, “See you tonight” may be selected as a topic for the communication. That is, in a display of received communications, the phrase “See you tonight” may become a default topic for the communication which is of little relevance to the substance of the communication and will provide very little assistance to a subsequent user who needs to know the topic or subject of the communication. Referring to FIG. 1B, a second communication in the example communication thread includes the message “Anyone interested in bringing food to the practice tonight?” As with the message illustrated in FIG. 1A, without automatic detection, generation and storage of a topic for the communication illustrated in FIG. 1B, an initial portion of the communication such as the phrase 115 of “Anyone interested” may be selected as a topic for the communication which will be of very little value to a subsequent user in knowing the topic or subject of the communication.

Referring now to FIG. 1C, an additional communication forming part of the three-message thread includes the message “I can bring food and some drinks to tonight's softball practice.” As with the messages illustrated in FIGS. 1A and 1B, without the automatic detection, generation and storage of a topic for the illustrated message according to embodiments of the present invention, an initial text string 125 such as “I can bring food” may be selected and displayed as a topic for the communication illustrated in FIG. 1C. Alternatively, the receipt dates/times, sender name, recipient name, or similar information may be used to generate a topic for each of the communications which will likewise be of little value to subsequent users reading or searching the communications. As can be seen, such topics generated and displayed in association with the displayed communications provide very little information to users of the communications as to the topics or subject matter associated with the communications and the conversation thread comprised of the communications.

According to embodiments of the invention, and as described in detail below, information contained in each of the communications comprising a conversation thread including terms contained in each of the communications and including data properties associated with the communications may be utilized for automatically detecting, generating and storing a topic title for the conversation thread that is relevant to the information contained in the conversation thread and that is helpful to subsequent users of the thread in quickly understanding the subject matter of thread and in performing searches on the thread. For example, referring still to FIGS. 1A, 1B, and 1C, each of the three communications comprising the conversation thread includes terms that identify the primary subject of each of the communications as relating to a softball practice being held tonight. According to embodiments, an example topic title, such as “Tonight's softball practice” may be generated, stored and associated with the conversation thread for allowing users of the conversation thread to quickly understand the subject matter of the conversation thread and to allow more efficient future searching on the stored conversation thread.

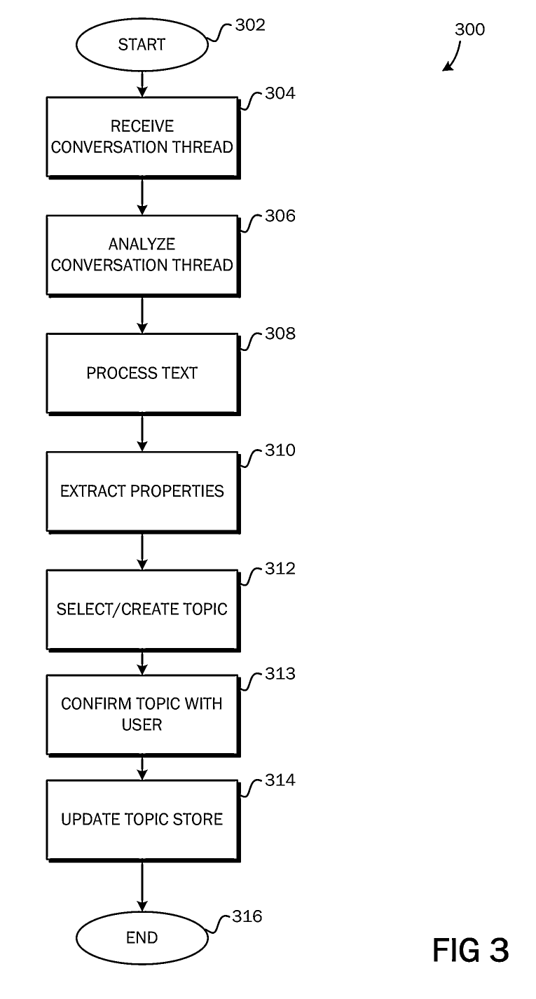

FIG. 1D illustrates a communication displayed in an example user interface showing a generated topic title, and FIG. 1D further illustrates a user interface component for allowing a user to accept or modify a generated topic title. As illustrated in the example handheld device display screen, a new topic title generated as described below from the information in and associated with the conversation thread illustrated in FIGS. 1A, 1B and 1C is displayed above the communication. That is, an example newly generated topic title of “Softball practice tonight with food and drinks” has been generated and displayed. According to embodiments, and as described below with respect to FIG. 3, before such a generated topic title is stored, the topic title may be presented as a candidate title to a user of the conversation thread for acceptance, rejection or modification. As illustrated in FIG. 1D, a user interface component 145 provides the candidate topic title in a “suggested topic title” field 155. If the user accepts the suggested title, the suggested or candidate title is stored as the topic title for the conversation thread. If the user does not accept the candidate title, the user may reject the title, or the user may offer a replacement title in a “replacement title” field 165.

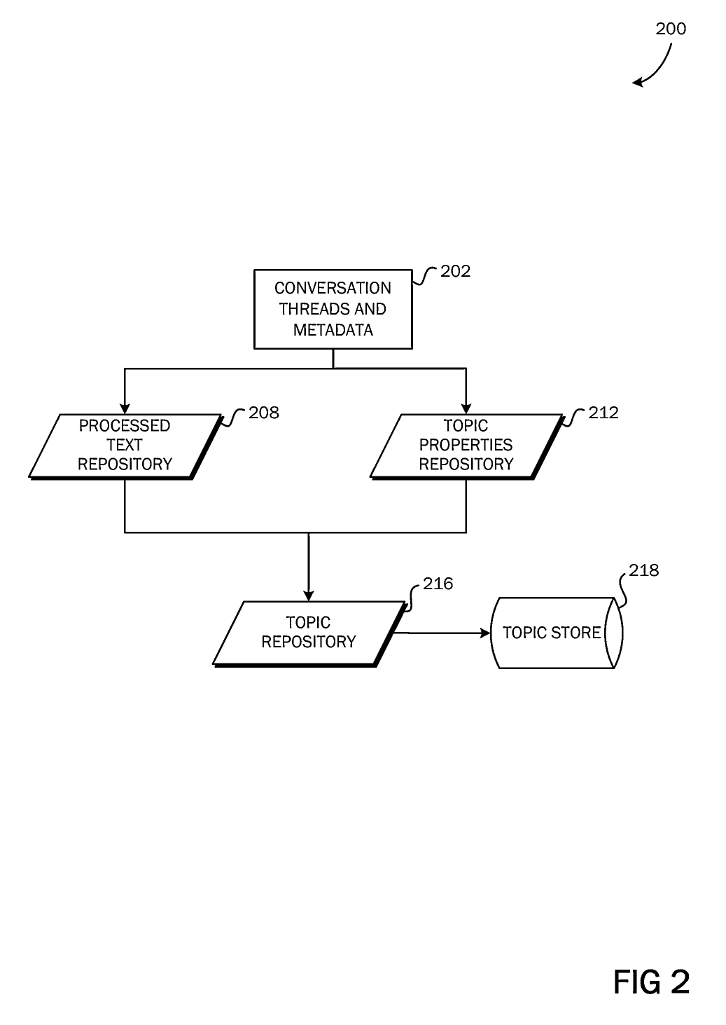

FIG. 2 illustrates a system architecture for automatically detecting and identifying a conversation topic associated with an electronic conversation thread. As briefly described above with respect to FIGS. 1A, 1B and 1C, a variety of information, data and properties is extracted from communications comprising a conversation thread and obtained from one or more local and external sources for use in automatically detecting, generating and storing a topic title for a given conversation thread. As communications are sent and received comprising a conversation thread, the communications comprising the conversation thread and various metadata items associated with the communications are stored in a data repository, for example, a repository operated by a communications services provider associated with the conversation thread.

Data repository 202 is illustrative of one or more memory storage areas at which conversation threads, communications comprising conversation threads and metadata items associated with conversation threads may be stored and from which information about the conversation threads may be obtained for use in detecting, generating and storing topic identifications (i.e., topic titles) for conversation threads. For example, the communications illustrated in FIGS. 1A, 1B and 1C may be stored in the repository 202, and metadata items, for example, identification of communication senders, identification of communication receivers, dates/times of communication transmission and receipt, subject lines manually entered for any communications comprising the conversation threads, previously generated and stored topic titles for the conversation threads, relation between a given conversation thread or communications comprising the conversation thread and other communications or other conversation threads, and the like may be obtained.

In order to detect and generate a topic title for a given conversation thread, text contained in communications comprising a given conversation thread is processed into individual keywords or terms and the processed text may be stored in a processed text repository 208 for subsequent use in generating a topic for a given conversation thread. In addition, a variety of topic properties, as described above, for example, communication sender, communication receiver, communication date/time, and the like are extracted from the communications comprising a given conversation thread and are stored in a topic properties repository 212. As described below, analysis of the processed text in association with the extracted topic properties leads to the generation of a topic and topic title 216 for the conversation thread.

Once the topic/topic title 216 is accepted for the associated conversation thread either automatically or via user verification, the topic/topic title 216 may be stored in a topic store 218 for subsequent use in association with the conversation thread. In addition, the topic 216 may be stored with the conversation threads and metadata repository 202 or in any other suitable local or remote storage location for associating with the communications comprising the conversation thread and with the conversation thread in general.

FIG. 3 illustrates a process flow for automatically detecting and identifying a conversation topic associated with an electronic conversation thread. The method 300 begins at start operation 302 and proceeds to operating 304 where a first conversation thread is received from the conversation thread and metadata repository 202. For example, the conversation thread comprised of three communications illustrated at FIGS. 1A, 1B, and 1C may be retrieved from the conversation threads and metadata repository for detection generation and storage of a topic and topic title for the retrieved conversation thread. As described above, in the case of the communications, illustrated in FIGS. 1A, 1B and 1C, the conversation thread and associated metadata repository 202 may be associated with one or more communications services providers responsible for providing the communications systems necessary for the communications illustrated in FIGS. 1A, 1B and 1C.

At operation 306 the received conversation threads and metadata are analyzed and formatted as necessary for text processing required for detecting and generating topics and topic titles. According to embodiments, the conversation thread analysis may be performed by a text parser operative to parse text contained in the retrieved conversation threads and associated metadata for processing the text into one or more text components (e.g., sentences and terms comprising the one or more sentences). For example, if the conversation threads and associated metadata are formatted according to a structured data language, for example, Extensible Markup Language (XML), the conversation thread analysis may include parsing the retrieved conversation threads and associated metadata according to the associated structured data language for processing the text as described herein. For another example, the conversation threads and associated metadata may be retrieved from an online source such as an Internet-based chat forum where the retrieved text may be formatted according to a formatting such as Hypertext Markup Language (HTML). According to embodiments, the conversation thread analysis may include formatting the retrieved conversation threads and associated metadata from such a source so that it may be processed for conversation topics as described herein.

At operation 308, the text included in the communications comprising the conversation thread is processed for use in detecting, generating and storing a topic title for the conversation thread. A text processing application may be employed whereby the text is broken into one or more text components for determining whether the received/retrieved text may be contain terms that may be formed into a topic title for the conversation thread. Breaking the text into the one or more text components may include breaking the text into individual sentences followed by breaking the individual sentences into individual tokens, for example, words, numeric strings, etc.

Such text processing is well known to those skilled in the art and may include breaking text portions into individual sentences and individual tokens according to known parameters. For example, punctuation marks and capitalization contained in a text portion may be utilized for determining the beginning and ending of a sentence. Spaces contained between portions of text may be utilized for determining breaks between individual tokens, for example, individual words, contained in individual sentences. Alphanumeric strings following known patterns, for example, five digit numbers associated with zip codes, may be utilized for identifying portions of text. In addition, initially identified sentences or sentence tokens may be passed to one or more recognizer programs for comparing initially identified sentences or tokens against databases of known sentences or tokens for further determining individual sentences or tokens. For example, a word contained in a given sentence may be passed to a database to determine whether the word is a person's name, the name of a city, the name of a company, or whether a particular token is a recognized acronym, trade name, or the like. As should be appreciated, a variety of means may be employed for comparing sentences or tokens of sentences against known, words, or other alphanumeric strings for further identifying those text items. For example, referring to the example communications illustrated in FIGS. 1A, 1B, 1C, text processing may include breaking each of the communications into individual words so that keywords such as “tonight,” “softball,” and “practice” may be utilized in association with other properties or other words obtained for the communications in automatically detecting and generating a topic title for the conversation thread made up of each of the three example communications.

At operation 310, properties associated with the communications comprising the conversation thread are extracted for use in association with processed text in automatically detecting and generating a topic title for the conversation thread. As described above, properties extracted for each of the communications comprising the conversation thread may include such properties as communication keywords, identification of communication senders, identification of communication receivers, dates/times of communication transmission and receipt, subject lines manually entered for any communications comprising the conversation threads, previously generated and stored topic titles for the conversation threads, relation between a given conversation thread or communications comprising the conversation thread and other communications or other conversation threads, and the like.

Additional properties that may be extracted about the one or more communications comprising the retrieved conversation thread include previous topics that may have been generated and stored for one or more of the communications in association with a different conversation thread, information on participants of the different conversation thread, information on any previous analysis of the text and properties associated with any of the communications comprising the conversation thread for generating a previously generated topic title for the conversation thread, and the like. That is, a topic may have been generated for the example conversation thread previously, and an additional communication, for example, the communication illustrated in FIG. 1C may have been added to the conversation thread requiring the previously generated topic title to be revised or updated, as described below.

At operation 312, a topic for the received conversation thread may be selected or generated. For example, as described above, if a topic title for the received conversation thread previously has been generated for the conversation thread, and additional communications have been received and now have been added to the conversation thread, the previous topic title may be selected to remain as the topic title for the conversation thread, or a new topic title may be generated, or the previous topic title may be revised based on text contained in the new communications and additional properties extracted from the new communications in association with the properties and text previously extracted from other communications comprising the conversation thread.

Continuing with operation 312, a topic identification is accomplished wherein the system 200 checks previously generated and stored topics and their properties to identify similarities or to decide whether a new topic title should be generated or whether an existing topic title for the received conversation thread should remain the same (persisted) or should be revised. That is, a determination is first made as to whether a topic title previously has been generated and stored for the received conversation thread, and an analysis is performed by comparing processed text terms and properties that were utilized for generation of the previously generated topic title with additional text and properties associated with newly added communications to determine whether similarities exist between the previous text terms and properties and the text terms and properties associated with newly added communications in order to determine whether the previously generated topic title may continue in use with the received conversation thread even with the addition of new communications to the conversation thread.

Referring back to FIGS. 1A, 1B, and 1C, a first topic may have been generated for the conversation thread in association with the communications illustrated in FIGS. 1A and 1B only. An example first topic may have been something such as “softball practice tonight.” However, if the communication illustrated in FIG. 1C is added to the conversation thread, an analysis of the terms and properties associated with the newly added communication include information about the bringing of food and drinks to the example softball practice. Thus, in view of extracted text terms and properties associated with the additional communication, an updated topic title for the conversation thread including the newly added communication may be generated to include information about the food and drinks such that a new topic of “food and drinks at softball practice tonight” may be generated that reflects the change in the conversation thread. On the other hand, if terms associated with food and drinks had previously been included in other communications associated with the conversation thread, the determination may be made to continue with the previously generated topic title for the conversation thread even with the addition of the new communication to the conversation thread.

If a topic title has not previously been generated for the received conversation thread, then the text terms extracted from the communications comprising the conversation thread and properties extracted for each of the communications comprising the conversation thread may be utilized for generating a new topic title for the conversation thread. Referring still to the example communications illustrated in FIGS. 1A, 1B, and 1C, properties associated with each of the three communications may indicate common senders and receivers of the communications and may indicate that the communications have been sent and received within a short time frame. In addition, similar terms found throughout each of the three communications, for example, “softball,” “practice,” “tonight,” “food,” and “drinks,” may be used to generate a new topic of “softball practice tonight food and drinks.” Such a topic stored for the conversation thread would then allow any user reviewing the conversation thread to immediately realize that the conversation thread and the communications comprising the conversation thread are associated with a softball practice occurring tonight and that food and drinks will be involved with the practice. Thus, the topic generated and stored for the conversation thread provides users with a very helpful indication as to the subject matter of the communications comprising the conversation thread and allows the users to easily search on the communications comprising the conversation thread if the users desire more information about those communications or about the conversation thread in general.

At operation 313, the new, revised or existing topic may be presented to a user of the conversation thread to allow a user to verify that the new, revised or existing topic is an accurate topic for the conversation thread. For example, a user interface component, as illustrated above in FIG. 1D, may be launched on the display screen of a user device with which the conversation thread is reviewed, and the new, existing or revised topic title may be presented to the user as a suggested title 155 to ask the user if the topic is an acceptable topic title for the conversation thread. If the user acknowledges that the presented topic title is an acceptable topic for the conversation thread, then the presented topic may be stored for the conversation thread, as described below. If the presented topic title is not accepted by the user as an acceptable topic title for the conversation thread, the user may be presented with a field 165 for providing additional text or for providing a suggested replacement topic title, and the suggested replacement topic title from the user may be broken into key terms, and may be utilized for revising the topic as described herein. Alternatively, if the user provides a suggested topic title, the suggested topic title may be used to override the topic generated or revised by the system 200, and the topic title suggested by the user may be stored for use in association with the received conversation thread as described below.

At operation 314, whether a new topic is generated for the received conversation thread, or whether an existing topic is revised, or whether an existing topic is maintained for the conversation thread, the topic title that will be used for the conversation thread whether new, existing, or revised, is stored in the topic store 218 and is associated with the conversation thread so that subsequent use of the conversation thread is identified with a stored topic. If conversation thread is long, several topics and associated topic titles may be identified over time even though the conversation thread identification (Id) is the same. According to an embodiment, in order to distinguish different topics for different portions of a long thread, a value pair may be assigned that relates the thread ID with the date and time of the topic association, for example, value pair=(thread Id, date/time). So, as a conversation thread grows ever longer, topics and associated topic titles may be generated and associated with different portions of the thread.

In addition, extracted text terms and all properties associated with the new, revised, or existing topic are likewise stored in the topic store for use with subsequent generation, revision, or maintenance of topics associated with the conversation thread. In addition to storing the new, existing or revised topic, topic title and associated properties and text terms in the topic store 218, such information associated with the conversation thread may be stored with the conversation threads and metadata repository 202 which may exist locally or remotely at one or more data repositories.

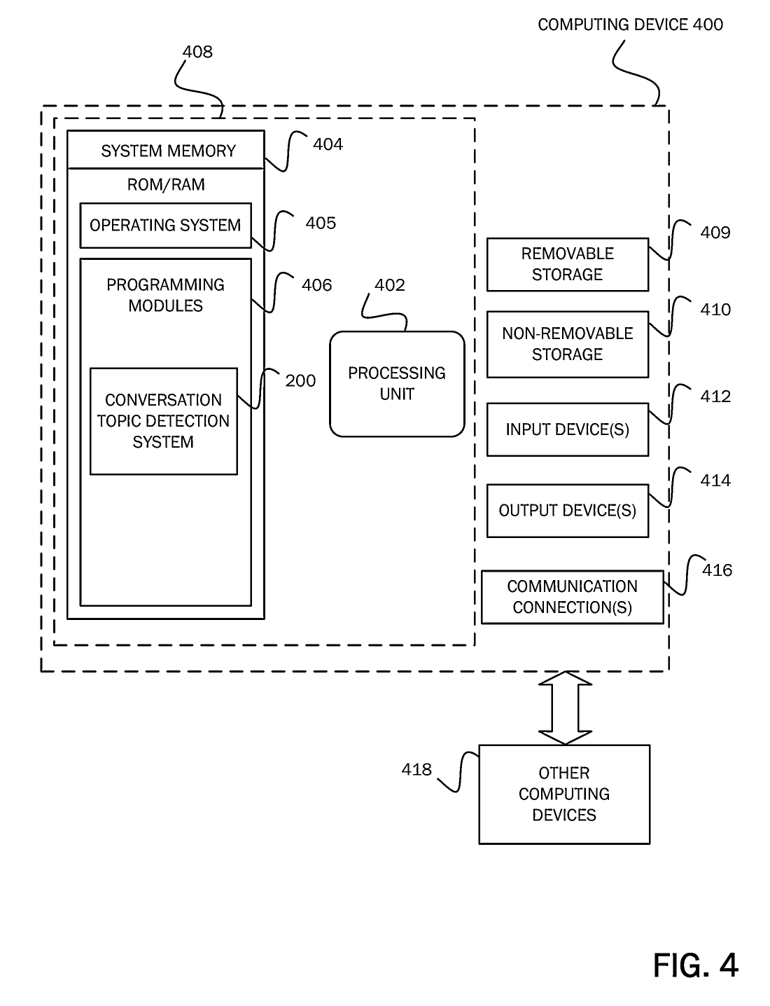

As described above, embodiments of the invention may be implemented via local and remote computing and data storage systems, including the systems illustrated and described with reference to FIGS. 1A, 1B, 1C, 1D, 2 and 3. Consistent with embodiments of the invention, the aforementioned memory storage and processing unit may be implemented in a computing device, such as computing device 400 of FIG. 4. According to embodiments, the computing device may be in the form of a personal computer, server computer, handheld computer, smart phone, tablet or slate device, or any other device capable of containing and operating the computing components and functionality described herein. In addition, the computing device components described below may operate as a computing system printed on a programmable chip. Any suitable combination of hardware, software, or firmware may be used to implement the memory storage and processing unit. For example, the memory storage and processing unit may be implemented with computing device 400 or any other computing devices 418, in combination with computing device 400, wherein functionality may be brought together over a network in a distributed computing environment, for example, an intranet or the Internet, to perform the functions as described herein. The aforementioned system, device, and processors are examples and other systems, devices, and processors may comprise the aforementioned memory storage and processing unit, consistent with embodiments of the invention. Furthermore, computing device 400 may comprise operating environment 100 as described above. Operating environment 100 is not limited to computing device 400.

With reference to FIG. 4, a system consistent with embodiments of the invention may include a computing device, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include operating system 405, one or more programming modules 406, and may include the conversation topic detection, generation and storage system 200 having sufficient computer-executable instructions, which when executed, performs functionalities as described herein. Operating system 405, for example, may be suitable for controlling computing device 400's operation. Furthermore, embodiments of the invention may be practiced in conjunction with a graphics library, other operating systems, or any other application program and is not limited to any particular application or system. This basic configuration is illustrated in FIG. 4 by those components within a dashed line 408.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computing device 400 may also contain a communication connection 416 that may allow device 400 to communicate with other computing devices 418, such as over a network in a distributed computing environment, for example, an intranet or the Internet. Communication connection 416 is one example of communication media.

As stated above, a number of program modules and data files may be stored in system memory 404, including operating system 405. While executing on processing unit 402, programming modules 406 and may include the automatic glossary generation system 200 which may be a program module containing sufficient computer-executable instructions, which when executed, performs functionalities as described herein. The aforementioned process is an example, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The term computer readable media as used herein may include computer storage media. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a touch input device, etc. Output device(s) 414 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

We claim:

1. A method of automatically generating an electronic conversation topic, comprising:
receiving a conversation thread comprised of one or more electronic communications;
comparing one or more text components from each of the one or more communications with the one or more text components from each of the other of the one or more communications to find common or similar text components in two or more of the one or more communications; and
if the properties extracted from each of the one or more communications establishes a relationship between two or more of the one or more communications, generating a topic title for the conversation thread from common or similar text components found in two or more of the one or more communications.

2. The method of claim 1, further comprising associating the generated topic title with the retrieved conversation thread.

3. The method of claim 2, further comprising storing the generated topic title associated with the retrieved conversation thread for subsequent retrieval with the retrieved conversation thread.

4. The method of claim 1, prior to generating a topic title for the conversation thread, determining whether an existing topic title has already been generated for the conversation thread.

5. The method of claim 4, wherein if an existing topic title has already been generated for the conversation thread, determining whether one of the one or more communications comprising the conversation thread was added to the conversation thread after the existing topic title was generated for the conversation thread.

6. The method of claim 5, wherein if one of the one or more communications comprising the conversation thread was added after the existing topic title was generated for the conversation thread, determining whether text components comprising the one of the one or more communications that was added to the conversation thread after the existing topic title was generated for the conversation thread requires revision of the existing topic title that was generated for the conversation thread; and if revision of the existing topic title is required, revising the existing topic title to incorporate one or more text components of the one or more communications that was added to the conversation thread after the existing topic title was generated.

7. The method of claim 1, prior to generating a topic title for the conversation thread, presenting a candidate topic title to a user of the retrieved conversation thread for user acceptance of the candidate topic title as a correct topic title for the conversation thread.

8. The method of claim 7, wherein if the user accepts the candidate topic title as a correct topic title for the conversation thread, generating the topic title for the conversation thread from the candidate topic.

9. The method of claim 8, wherein if the user does not accept the candidate topic title as a correct topic title for the conversation thread, receiving a modified topic title from the user and generating the modified topic title as a corrected topic title for the conversation thread.

10. The method of claim 1, prior to comparing one or more text components from each of the one or more communications with the one or more text components from each of the other of the one or more communications to find common or similar text components in two or more of the one or more communications, processing the one or more communications comprising the received conversation thread including breaking the one or more communications comprising the conversation thread into text components that may be used for generating a topic title for the conversation thread.

11. The method of claim 10, prior to breaking the one or more communications comprising the conversation thread into text components, further comprising formatting the one or more communications comprising the conversation thread for generating a topic title for the conversation thread.

12. The method of claim 1, wherein generating the topic title for the conversation thread includes revising an existing topic title previously generated for the conversation thread.

13. The method of claim 1, wherein generating the topic title for the conversation thread includes maintaining an existing topic title previously generated for the conversation thread.

14. The method of claim 1, wherein receiving a conversation thread comprised of one or more electronic communications includes receiving a communication thread comprised of one or more text messages.

15. The method of claim 1, wherein receiving a conversation thread comprised of one or more electronic communications includes receiving a conversation thread comprised of one or more electronic mail messages.

16. The method of claim 1, wherein receiving a conversation thread comprised of one or more electronic communications includes receiving a conversation thread comprised of one or more electronic messages from an electronic discussion board.

17. The method of claim 1, wherein receiving a conversation thread comprised of one or more electronic communications includes receiving a conversation thread comprised of one or more electronic communications from an Internet-based chat forum.

18. A computer readable medium containing computer executable instructions which when executed by a computer perform a method of automatically generating an electronic conversation topic, comprising:
receiving a conversation thread comprised of one or more electronic communications;
extracting one or more properties associated with each of the one or more communications, the one or more properties providing identification information for the one or more communications to which they are associated;
comparing the one or more text components from each of the one or more communications with the one or more text components from each of the other of the one or more communications to find common or similar text components in two or more of the one or more communications;
if the properties extracted from each of the one or more communications establishes a relationship between two or more of the one or more communications, generating a topic title for the conversation thread from common or similar text components found in two or more of the one or more communications;
associating the generated topic title with the retrieved conversation thread; and
storing the generated topic title associated with the retrieved conversation thread for subsequent retrieval with the retrieved conversation thread.

19. The computer readable medium of claim 18,
prior to generating a topic title for the conversation thread, presenting a candidate topic title to a user of the retrieved conversation thread for user acceptance of the candidate topic title as a correct topic title for the conversation thread;
wherein if the user accepts the candidate topic title as a correct topic title for the conversation thread, generating the topic title for the conversation thread from the candidate topic; and
wherein if the user does not accept the candidate topic title as a correct topic title for the conversation thread, receiving a modified topic title from the user and generating the modified topic title as a corrected topic title for the conversation thread.

20. A method of automatically generating an electronic conversation topic title, comprising:
receiving a conversation thread comprised of one or more electronic communications;
formatting the one or more communications comprising the conversation thread for generating a topic title for the conversation thread;
breaking the one or more communications comprising the conversation thread into text components that may be used for generating a topic title for the conversation thread;
extracting one or more properties associated with each of the one or more communications, the one or more properties providing identification information for the one or more communications to which they are associated;
comparing the one or more text components from each of the one or more communications with the one or more text components from each of the other of the one or more communications to find common or similar text components in two or more of the one or more communications;
if the properties extracted from each of the one or more communications establishes a relationship between two or more of the one or more communications, generating a topic title for the conversation thread from common or similar text components found in two or more of the one or more communications; and
storing the generated topic title associated with the retrieved conversation thread for subsequent retrieval with the retrieved conversation thread.
